(19) United States
(12) Patent Application Publication
(10) Pub. No.: US 2025/0253074 A1
(43) Pub. Date: Aug. 7, 2025

(54) Use Of A Cable Guide

(71) Applicant: HAUFF-TECHNIK GMBH & CO. KG, Hermaringen (DE)

(72) Inventors: Ralf Kurz, Giengen (DE); Jörg Schmid, Niederstotzingen (DE)

(21) Appl. No.: 18/856,343

(22) PCT Filed: Apr. 25, 2023
(86) PCT No.: PCT/EP2023/060804

§ 371 Date: Oct. 11, 2024

(30) Foreign Application Priority Data
Apr. 26, 2022 (DE) 102022110044.8
Apr. 26, 2022 (DE) 102022110061.8

(51) Int. Cl. H01B 17/58

(52) U.S. Cl. CPC H01B 17/583

(57) ABSTRACT

The invention relates to a use of a line bushing (1) which has a bushing sleeve (2), through which a line can be guided along a center axis (9) of the bushing sleeve (2), and a flange part (3) for abutting against a side face (51.1) of the wall or floor element (51), wherein the bushing sleeve (2) is tiltably mounted on the flange part (3) for changing a tilt angle, and wherein the tiltable mounting is realized via an elastomeric deformation element (28) as a joint (39) for installation in a passage opening (50) in a wall or floor element (51) of a building, wherein the bushing sleeve (2) is inserted into the passage opening (50) in such a way that the flange part (3) abuts against the side face (51.1) of the wall or floor element (51).

The present invention relates to the use of a line bushing for installation in a wall or floor element of a building.

In the course of use, the line bushing is inserted into a passage opening and fastened therein. In the process, the line can already be led through and also installed; alternatively, however, an empty pipe can also be led through and fastened first, the actual line then being laid only later. The passage opening can be, in particular, a hole which is subsequently introduced into an already existing wall or floor element, for example in the course of a subsequent connection of the building to the corresponding line network. A preferred application can be a glass fiber connection, the line is therefore preferably a glass fiber cable.

The present invention is based on the technical problem of specifying an advantageous use or line bushing as the subject matter of the use.

This is achieved according to the invention with the features according to claim 1. The corresponding line bushing has a bushing sleeve and a flange part on which the bushing sleeve is tiltably mounted. This permits assembly even in the case of a tilted passage opening, for example if the latter extends obliquely upward from the ground through the building wall, that is to say if, in general terms, a longitudinal axis of the passage opening is tilted with respect to a surface normal on the side face of the wall or floor element. A peculiarity in the present case is that this tiltability is realized via an elastomeric joint, that is to say with an elastomeric deformation element as a joint. This can be simplified in terms of production for instance in comparison with a joint with joint faces which abut against one another (for example spherically in the case of a ball joint), especially since joint faces which abuts against one another can be at risk of contamination and consequently be more demanding during handling/assembly. The elastomeric joint can represent a simple and robust alternative.

Preferred embodiments can be found in the dependent claims and the entire disclosure, which always relates both to use aspects and method and device aspects; in any case implicitly, the disclosure should always be read with regard to all claim categories.

In detail, the tiltability between flange part and bushing sleeve means that the tilt angle between the center axis of the bushing sleeve and a surface normal which is perpendicular to the side face of the wall or floor element can be changed. In general, when the bushing sleeve is tilted, the elastomeric joint can be compressed on a radial side thereof and can be expanded on the radially opposite side (the center axis is tilted toward the former, it is tilted away from the latter).

The tiltability is preferably symmetrical, that is to say that, in other words, in the unloaded state, when no external force for tilting is applied, the center axis of the bushing sleeve is perpendicular to a plane defined by the abutment of the flange part (in the mounted state, this plane lies parallel to the side face of the wall or floor element or coincides with the latter). In simplified terms, the line bushing is preferably provided in such a way that, in the case of a passage opening perpendicularly to the side face, the bushing sleeve can be inserted without tilting relative to the flange part, that is to say without elastic deformation of the elastomeric joint.

Around the center axis of the bushing sleeve, an annular space within the bushing sleeve, which is delimited by the latter together with a line laid through or preferably an empty pipe (see below in detail), is at least symmetrical around an axis, preferably rotationally symmetrical. “Inner” and “outer” relate, without expressly indicating the opposite, to the radial direction, that is to say that an inner or inner wall surface faces, for example, the center axis of the bushing sleeve and/or the longitudinal axis of the passage opening, whereas an outer or outer wall surface faces away. Particulars such as “axial”, “radial” and “circumferential”, and the associated directions (“axial direction” etc.) relate, without indicating the opposite, to the center axis of the bushing sleeve, in particular of the portion thereof arranged in the passage opening. In the mounted state, the center axis of the bushing sleeve is preferably coaxial with a longitudinal axis of the passage opening.

As discussed in detail below, at least one layer of the flange part and one layer of the bushing sleeve are preferably formed monolithically with one another, namely from the same elastomer material. In general, “monolithically” means, without interruption, continuously from the same material, without a material boundary therebetween. In the transition between the bushing sleeve and the flange part, the elastomeric joint is formed, in this case monolithically with the flange part (at least the layer thereof) and the bushing sleeve (at least the layer thereof). The elastomeric joint can be provided radially outside the bushing sleeve between the latter and the flange part; however, on the other hand, it can also be formed between an insertion portion and an injection portion of the bushing sleeve, cf. the following remarks on the axial arrangement.

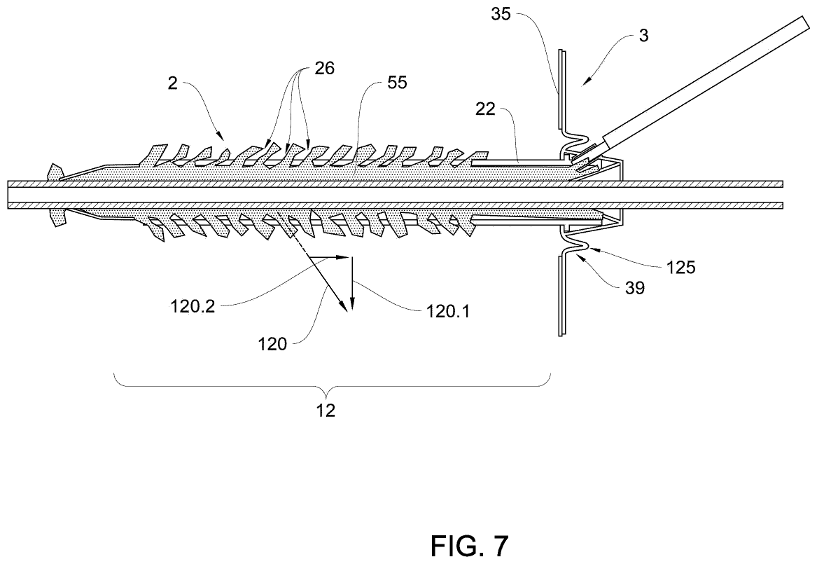

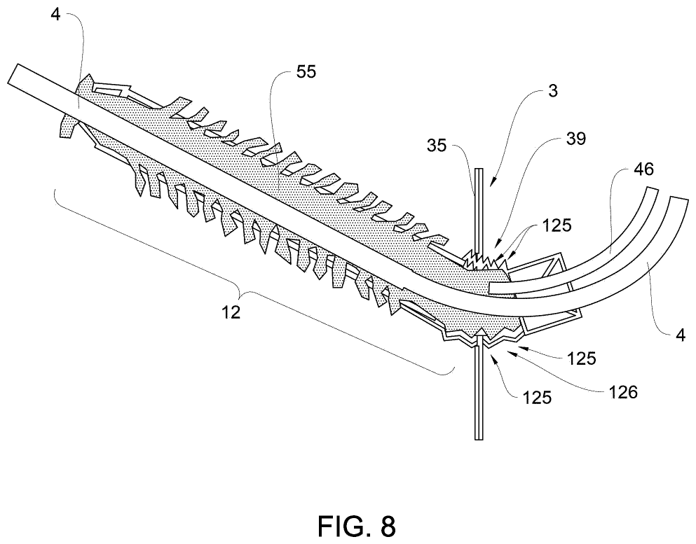

In order to simplify the deformation and thus tilting of the elastomeric joint, the latter can have, for example, a jacket wall which is provided with a circumferential projection and/or indentation, wherein the projection and/or indentation is/are further preferably each circumferentially closed in itself. As it were, excess material is available with the projection and/or indentation, which can simplify the deformation/deflection. Preferably, one projection and one indentation follow one another, particularly preferably a plurality of projections follow one another, between which in each case one indentation is provided. In the process, when viewed in an axial section containing the center axis, the projection(s) and indentation(s) can follow one another radially and/or axially (cf. FIG. 7 for illustration of “radial” and FIG. 8 with respect to “axial”).

In the case of the radial arrangement, the jacket wall of the elastomeric joint can extend from an inner radial position on the bushing sleeve to an outer radial position on the flange part; when viewed in an axial plan view, this/these projection(s) and indentation(s) can represent, for example, rings nested one inside the other. In the case of the axial arrangement, by contrast, the projection(s) and indentation(s) follow one another axially, that is to say they represent, for example, lines which are offset with respect to one another in a radial plan view, in particular respective axially perpendicular lines. Furthermore, a combination of radial and axial offset is also possible; the jacket wall, specifically a straight line of best fit placed into the jacket wall when viewed in the axial section, can thus lie obliquely with respect to the center axis.

In the case of the axial arrangement, the jacket wall of the elastomeric joint, which jacket wall is provided with the projection(s) and indentation(s), extends between two axial positions, wherein an insertion portion (see below) of the bushing sleeve can be arranged at one end-side axial position and the flange part can be arranged at the other end-side axial position; alternatively, however, the flange part can also be provided between the two axial positions. In particular, an injection portion of the bushing sleeve can then lie at the other axial position. In other words, in the case of this variant, there can be a portion provided with projection(s) and indentation(s) axially on both sides of the flange part and therefore also outside the passage opening. This and the insertion portion of the bushing sleeve can then be tiltable with respect to one another via the elastomeric joint, which can be of interest, for example, with regard to a suitable line routing outside the wall or floor element or a suitable orientation for the filling substance supply.

However, the elastomeric joint does not necessarily have projections/indentations; it can also be embodied, for example, as a thickened region in comparison with an elastomeric layer of the flange part and/or of the bushing sleeve. When viewed in an axial section, this thickened region can form, for example, a hollow groove between flange part and bushing sleeve, preferably axially on both sides of the flange part.

In a preferred embodiment, the bushing sleeve is mounted in an oblique passage opening, the longitudinal axis of which is therefore tilted with respect to a surface normal on the side face. The angle between longitudinal axis and surface normal can be, for example, at least 10°, 20°, or 30° (increasingly preferred in the order of mention); possible upper limits can be, for example, at most 70°, 60°, or 50°. In this case, the line bushing per se is preferably provided such that the center axis of the bushing sleeve, in the unloaded state, is perpendicular to the plane defined by the abutment of the flange part, see above.

According to a preferred embodiment, an insertion portion of the bushing sleeve is arranged on one axial side of the flange part, and the bushing sleeve also extends proportionally on the opposite axial side of the flange part; namely, an injection portion of the bushing sleeve is arranged there. In other words, the flange part is arranged on the bushing sleeve at an axial position spaced apart from both axial ends of the bushing sleeve. In this case, the elastomeric joint can be arranged axially between the insertion portion and the injection portion; however, the elastomeric joint is then preferably arranged radially outside the bushing sleeve, and the insertion portion and injection portion directly adjoin one another. During assembly, the insertion portion is inserted into the passage opening until the flange part abuts against the side face; the opposite injection portion then projects out of the passage opening, for example, by at least 1 cm, 2 cm, or 3 cm (with possible upper limits at, for example, at most 15 cm, 10 cm, or 5 cm).

As discussed in detail below, the bushing sleeve, together with a line laid through or preferably an empty pipe laid through, delimits an annular space, in particular a circular annular space, wherein the latter then also extends proportionally outside the passage opening (when the bushing sleeve is inserted until the flange part abuts against the side face). A filling substance for fastening the line bushing in the passage opening can advantageously be introduced via this annular space, from the injection portion into the insertion portion. A resin, for example, based on polyurethane, is preferably provided as the filling substance.

The filling substance is injected axially or, for example, via a filling opening which is provided in the injection portion in a jacket wall of the bushing sleeve. In comparison to an axial injection, for example, via an injection tube opening axially into the annular space, the injection through the jacket wall can allow, for example, a certain decoupling of the flow cross section available for the filling substance from the radial width of the annular space. For the passage opening, a relatively small diameter, for example, of less than 5 cm or 4 cm, can generally be preferred with regard to simplified drilling (for example, no core bore/no upright required); a possible lower limit can be, for example, at least 2 cm.

Radially inwards, for the dimension of the annular space, for example, a certain outer diameter of the line or preferably of the empty pipe guided through (for the line) can be limiting, which overall leads to a limited radial width. By placing the filling opening in the jacket wall, it can nevertheless be provided with a certain size, for example, a larger diameter in comparison to the radial width of the annular space, which can simplify, for example, the injection of the filling substance. In addition, the filling substance is already supplied to the annular space outside the passage opening, i.e., it can already be distributed (at least proportionally) outside the passage opening over the annular space and accordingly flow into the passage opening over a large flow cross section.

Since the filling substance is already supplied to the annular space (between bushing sleeve and line or preferably empty pipe) outside the passage opening, for example, no filling tube has to be inserted through the flange part or into the latter. This can simplify its geometry and be advantageous in particular with regard to the preferred production from an elastomer material (see below). Furthermore, no inlet tube running into the passage opening has to be taken into account in the dimensioning, i.e., the annular space can be correspondingly maximized.

According to a preferred embodiment, a connecting piece is provided which protrudes away from the jacket wall at the filling opening and forms an injection channel for the filling substance, to which, for example, an injection cartridge is connected. This injection channel opens into the annular space at the filling opening. The connecting piece is preferably oriented obliquely with respect to the center axis of the bushing sleeve, i.e., not parallel or perpendicular, but, for example, at an angle of at least 10°, preferably at least 20°, and, for example, not more than 80°, preferably at most 70°. As a result of this oblique orientation, the injection channel points towards the passage opening with respect to an injection direction, i.e., the filling substance has a directional component into the passage opening during the injection. At the same time, it is also distributed circumferentially in the annular space, i.e., the flow cross section is increased/utilized, which results in a good filling substance input into the passage opening in the overall view.

In general, the connecting piece can have, for example, a length, taken away from the jacket wall, of at least 1 cm, preferably at least 1.5 cm, with possible upper limits at, for example, at most 5 cm or 4 cm. In the process, the extent is respectively taken along a longitudinal axis of the connecting piece situated centrally in the injection channel, to which the above angle specifications also relate (wherein the angles can also be regarded as disclosed independently of the length, and vice versa). The connecting piece is preferably formed monolithically with at least one layer of the jacket wall of the bushing sleeve, i.e., integrally formed continuously without interruption (cf. also the above definition). The at least one layer is preferably formed from an elastomer material, from which the connecting piece is correspondingly also provided. The latter can be advantageous, for example, to the effect that the connecting piece can then be easily demolded despite its preferably oblique orientation, which can result in an undercut in a molding tool.

According to a preferred embodiment, the bushing sleeve is provided overall from an elastomer material, specifically monolithically with at least one layer of the flange part via the elastomeric joint. A further layer of the flange part then preferably forms a butyl band, see below in detail. The elastomeric layer of the flange part is preferably comparatively thin, which allows good pressing (see below).

The “elastomer material” is quite generally a plastic with elastic behavior. The Shore hardness (Shore A) thereof can be, for example, at most 90 Shore, 80 Shore, 75 Shore, or 70 Shore and (independently thereof), for example, at least 20 Shore, 25 Shore, 30 Shore, 35 Shore, or 40 Shore. It can be, for example, a rubber material, preferably a synthetic rubber, for instance EPDM (ethylene-propylene-diene, M group). However, it can also be, for example, a thermoplastic elastomer (TPE) or a silicone-based material, for instance silicone rubber or silicone elastomer.

According to a preferred embodiment, the sealing sleeve has a sealing collar at one end, in particular its flange-part-side end. Said end can be, for example, that end of the injection portion which faces away from the flange part and which lies outside the passage opening in the mounted state. However, the sealing collar can also be provided independently of an injection portion, for instance lie axially substantially at the same position as the flange part, that is to say, for example, in the mouth of the passage opening.

With the sealing collar, the bushing sleeve could generally also abut against the line itself; however, an empty pipe is or will be preferably led through and the sealing collar abuts against it. The sealing collar delimits the annular space in a direction away from the passage opening, that is to say prevents the filling substance from swelling out there. The sealing collar is preferably provided from an elastomer material (see above); it is particularly preferably formed monolithically with at least one layer of the bushing sleeve. It extends radially inwards from the jacket wall, preferably obliquely in the direction of the flange part (that is to say in the direction of the passage opening in the mounted state). A circumferentially closed (uninterrupted) sealing collar is advantageous, which accordingly also abuts against the empty pipe with a circumferentially self-contained sealing line. With the oblique orientation just described, a certain reinforcement of the sealing action can result if some filling substance spreads or expands in the direction away from the passage opening, namely the filling substance can press the sealing collar further inwards against the line or the empty pipe.

In general, in a preferred embodiment, the bushing sleeve has an outlet opening through which a filling substance supplied between line and bushing sleeve or empty pipe and bushing sleeve can emerge radially outwards. Preferably, a plurality of corresponding outlet openings are provided, wherein variants described below relate, inter alia, to the axial positioning thereof and possibilities for configuring the outlet openings per se are discussed further below.

According to a preferred embodiment, the jacket wall of the bushing sleeve is closed in a first axial portion in an insertion portion which is arranged in the passage opening in the mounted state, and is provided with a plurality of outlet openings in a second axial portion which follows away from the flange part. In the first axial portion, the annular space is therefore not open radially outwards; no filling substance emerges there. The injected filling substance is guided further in the first axial portion, i.e., therefore penetrates deeper into the passage opening. Since the filling substance typically expands in the course of curing, this can prevent, for example, lifting of the flange part from the side face, i.e., reduce an axial pressure on the flange part. Regardless of this, the configuration which is closed in the first axial portion can also create stability in the region of the elastomeric joint, i.e., where tilting forces are optionally introduced.

The first axial portion, in which the jacket wall is free of outlet openings, preferably extends over at least 1.5 cm, 2 cm, 2.5 cm, 3 cm, 3.5 cm, or 4 cm; possible upper limits can be (independently thereof), for example, at most 12 cm, 10 cm, or 8 cm (respectively axially taken away from the plane defined by the abutment of the flange part, specifically with the center axis of the bushing sleeve perpendicular to said plane).

In a preferred embodiment, a spacer is provided at least in the second axial portion on an inner wall surface of the jacket wall, which spacer keeps the jacket wall spaced apart from a line guided through or preferably the empty pipe guided through. Preferably, a plurality of spacers are provided circumferentially distributed and/or axially distributed, which spacers keep the jacket wall spaced apart from the outer wall surface of the empty pipe in order to define the annular space. The spacer or spacers is/are preferably formed monolithically with the jacket wall, at least one layer thereof, i.e., as projection(s) projecting radially inwards. The corresponding layer of the bushing sleeve is preferably in turn provided from an elastomer material (see above), which can then be easily demolded despite this contouring. Specifically in the case of the elastomer material, the spacer can, for example, also prevent the jacket from being placed against the empty pipe, i.e., keep the outlet opening(s) accessible for the filling substance.

According to a preferred embodiment, the jacket wall is elastically deformable at least in the second axial portion, i.e., formed from an elastomer material. In principle, a construction in several layers (for example, multi-layer) is also possible in this case (for example, from a rigid grid, on which an elastomer jacket which is raised therefrom rests); in this case, however, the jacket wall preferably consists of precisely one layer formed from the elastomer material (at least in the second axial portion). The elastomer material, see above with regard to possible material properties, is expanded radially under the pressure of the filling substance; as a result, the jacket wall is preferably pressed against a frame delimiting the passage opening. In principle, this is also possible independently of outlet openings arranged in the second axial portion; the sealing with respect to the frame can thus be created solely by the pressed-on elastomer jacket wall. However, a combination with the outlet openings is preferred; in the process, filling substance thus also emerges, which, for example, adheres to the frame.

In an alternatively preferred embodiment, the bushing sleeve is formed rigidly in the second axial portion; the jacket wall is thus formed there from a rigid material. This can be, for example, a metal or a hard plastic, for instance with a Shore hardness (D) of at least 40 Shore, further and particularly preferably at least 45 Shore, or at least 50 Shore; possible upper limits can be, for example, at most 100 Shore, further and particularly preferably at most 90 Shore, or at most 80 Shore (respectively D). In the case of the metal, the jacket wall can be provided, for example, from a grid, for instance wire mesh, or also a thin metal sheet, into which the outlet openings are punched. Such a subsequent introduction is also possible in the case of the hard plastic; however, the outlet openings are preferably already kept free during an injection molding production; they are thus taken into account in the molding tool.

According to a preferred embodiment, the jacket wall is constructed in several layers in the first axial portion, i.e., from at least two successive layers in the radial direction. In this case, one layer is formed from the elastomer material (see above), wherein a support sleeve supporting the elastomer material forms a further layer. The support sleeve is provided from a more rigid material compared to the elastomer material, for instance metal or a hard plastic; with regard to possible material parameters (Shore hardness, etc.), reference is made to the above paragraph. The support sleeve can generally be assembled with the elastomer part; however, the elastomer material is preferably integrally formed on the support sleeve. For this purpose, the support sleeve can, for example, be injection-molded with the elastomer material as an insert part, or the two can be injection-molded as a multicomponent injection-molded part.

In general, the support sleeve can stabilize the annular space in the first axial portion, i.e., guide the filling substance into the passage opening and/or reduce the pressure on the flange part. In general, the support sleeve can also be provided radially outside the elastomeric layer; however, it is preferably arranged radially inwards and the elastomeric layer radially outwards. In the axial direction, the support sleeve preferably extends beyond the flange part into the injection portion. In this case, it preferably extends axially at least beyond the filling opening, i.e., it also stabilizes the annular space in the region of the injection; particularly preferably, it extends as far as the axial end of the bushing sleeve. A support sleeve which is configured continuously without interruption between the first axial portion and the injection portion and which is arranged radially inside the elastomeric layer is preferred. This continuous configuration can particularly easily allow tilting via the elastomeric joint.

In the case of the jacket wall which is rigid in the second axial portion, it is preferably formed monolithically with the support sleeve. The rigid material can thus form a pipe piece which is provided with the passage openings in the second axial portion and can preferably be provided with a closed jacket wall in the first axial portion (the latter is not mandatory, however; it can also cover, for example, the openings actually present in the pipe piece in the elastomeric layer there). In the variant with the jacket wall formed from the elastomer material in the second axial portion, it is preferably provided monolithically with the elastomeric layer in the first axial portion.

In a preferred embodiment, at least one layer of the flange part is provided from an elastomer material, see above with regard to possible material details. In general, it can in this case additionally also have a hard component as a further layer, for example be formed as a multi-component injection-molded part with an integrated support structure. However, the flange part is preferably formed exclusively by the elastomer material and a bitumen/butyl band, which results in a particularly flexible flange which can thus be pressed well against the side face. This can also be facilitated by a comparatively thin-walled configuration (in the axial direction) of the elastomeric layer of the flange part, for example, with a thickness of at most 10 mm, 8 mm, 6 mm, 5 mm, or 4 mm (a lower limit can be, for example, at least 2 mm). In the case of the flange part, the layers are arranged axially successively.

The flange part preferably has a bitumen or butyl band on that side which is pressed against the side face. This preferably has a flat configuration, i.e., is thinner in the axial direction than in the radial direction when viewed in an axial section containing the center axis (wherein only a respectively cohesive part of the sealing band is viewed in the section, which thus lies on one side of the center axis in the section). The radial dimension of the respectively cohesive part can be, for example, at least 2, 3, or 5 times the axial dimension (possible upper limits are, for example, at most 50, 30, or 10 times). Independently of these details, the flat configuration can easily allow pressing, for example, in conjunction with the thin-walled elastomeric layer. The bitumen/butyl band can have, for example, an area of at least 4 cm², 6 cm², 20 cm², or 20 cm², with possible upper limits at, for example, at most 1000 cm², 700 cm², or 500 cm².

In a preferred embodiment, the flange part is formed monolithically with at least one layer of the bushing sleeve. The monolithic configuration can consist with the bushing sleeve overall if it is preferably formed overall from the elastomer material. It can consist, in particular, with at least one layer in the first axial portion and/or the injection portion, preferably both. In the case of the jacket wall which is flexible in the second axial portion, it is preferably also monolithic with the flange part or the layer thereof. Generally, the bushing sleeve is preferably a part produced at least proportionally by injection molding; namely, at least the elastomer material is injection-molded, for example from EPDM or TPE. The bushing sleeve and the flange part are particularly preferably produced from elastomer material as a single-component injection-molded part, after which, for example, the butyl band can then also be placed against the flange part.

As already mentioned, in the course of installation into the passage opening, an empty pipe is preferably first mounted in the passage opening and the actual line is later laid through it. The empty pipe can have, for example, an outer diameter of at least 5 mm and, for example, not more than 20 mm, in particular not more than 15 mm. Particularly advantageous outer diameters can be, for example, 7 mm, 10 mm, and 12 mm, wherein the installation technician can select a corresponding empty pipe on site and guide it with the filling substance through the bushing sleeve before it is fastened. In this case, the bushing sleeve can already be inserted into the passage opening; however, the empty pipe is preferably first pushed through the bushing sleeve and the two are then inserted together into the passage opening. If the bushing sleeve sits in the passage opening, the filling substance is supplied to the annular space, preferably via the injection portion arranged outside the passage opening, see above.

As already mentioned, according to a preferred embodiment, the bushing sleeve is provided with an exit opening. In a second (open) state, the exit opening connects a supply volume on the inside of the bushing sleeve to a filling volume on the outside thereof. The supply volume is delimited by the bushing sleeve, for example, together with the line or an empty pipe laid through; the filling volume on the outside delimits the bushing sleeve together with the frame of the passage opening. For fastening the line bushing, a flowable filling substance is supplied to the supply volume, which then penetrates proportionally into the filling volume via the exit opening and cures. Specifically in an initial phase, the filling substance can still be comparatively liquid and be held together or axially guided by the bushing sleeve.

A peculiarity of the present bushing sleeve can be, as mentioned above, the configuration of the exit opening; the opening cross section thereof widens automatically under the increasing pressure of the filling substance; the exit opening is therefore designed to open automatically. It can thus be provided in the initial phase (“first state”) with an at least smaller or also completely closed opening cross section. This prevents the filling substance from running out in the initial phase, wherein the automatic opening then allows a sufficient filling substance exit into the filling volume when the expansion and solidification process thereof begins. If the exit opening were to retain the flow cross section of the first state unchanged in this case, sufficient filling substance could no longer penetrate into the filling volume on account of the viscosity of the filling substance which increases over time. With the automatic opening, both an initial holding together and a later release of the filling substance into the filling volume can therefore be achieved.

Preferred embodiments can be found in the dependent claims and the entire disclosure, which always relates both to use aspects and method and device aspects; in any case implicitly, the disclosure should always be read with regard to all claim categories.

In a preferred embodiment, at least one sleeve body of the bushing sleeve is formed from a hard plastic; a preferred hard plastic material can have, for example, acrylonitrile-butadiene-styrene (ABS), polystyrene (PS) and/or polyethylene, particularly preferably consist of precisely one thereof. Also independently of the specific material, the hard plastic can have, for example, a Shore hardness (D) of at least 40 Shore, further and particularly preferably at least 45 Shore, or 50 Shore; possible upper limits are, for example, at most 100 Shore, further and particularly preferably at most 90 Shore, or 80 Shore (respectively D). The sleeve body can give the bushing sleeve its shape, i.e., in particular, define (and stabilize) the radial dimensions of supply volume and/or filling volume. The rigid sleeve body can generally also be combined with an elastomer portion which axially adjoins the sleeve body. The rigid sleeve body preferably extends over the entire length of the bushing sleeve; it thus defines the supply volume and/or filling volume, for example, over the entire length.

Independently of these details, the rigid sleeve body can simplify, for example, the insertion of the bushing sleeve into the passage opening, that is to say offer advantages during assembly. By the exit opening or openings being provided so as to open automatically in a manner described above, these “robust” handling properties can nevertheless be combined with a good filling substance release into the filling volume. The rigid sleeve body can also provide good forwarding of the filling substance in the interior (in the supply volume), so that the filling substance penetrates axially comparatively deep into the passage opening, specifically in the initial phase. The automatic opening under pressure then creates a good distribution outside.

Around the center axis of the bushing sleeve, for example, an annular space within the bushing sleeve, which is delimited by the latter together with a line laid through or preferably an empty pipe (see below in detail), is at least symmetrical around an axis, preferably rotationally symmetrical. “Inner” and “outer” relate, without expressly indicating the opposite, to the radial direction, that is to say that an inner or inner wall surface faces, for example, the center axis of the bushing sleeve and/or the longitudinal axis of the passage opening, whereas an outer or outer wall surface faces away. Particulars such as “axial”, “radial” and “circumferential”, and the associated directions (“axial direction” etc.) relate, without indicating the opposite, to the center axis of the bushing sleeve. In the mounted state, the center axis of the bushing sleeve is preferably coaxial with a longitudinal axis of the passage opening.

The exit opening or openings is/are arranged in a jacket wall of the bushing sleeve, which delimits the supply volume and filling volume. Without indicating the opposite, “a” and “an” should be read within the scope of the present disclosure as an indefinite article and thus always also as “at least one”. The bushing sleeve can therefore be provided, for example, with a plurality of exit openings. The plurality of exit openings are preferably designed to open automatically, as described above, particularly preferably with opening mechanisms of identical construction to one another (see below in detail). If reference is made in simplified form to “exit openings”, this also always relates, without indicating the opposite, to a plurality of openings which are each designed to open automatically. Preferably, a plurality of exit openings are provided circumferentially distributed and/or axially distributed.

In the detailed description of the opening mechanisms, reference is also made in simplified form to one or “the” exit opening in the singular, which should always also be read as a disclosure of a plurality of correspondingly designed exit openings.

According to a preferred embodiment, a flap is provided which at least partially covers the exit opening in the first state. The flap can cover the opening cross section, for example, to an extent of at least 50%, 70%, or 90%, or also completely (100%). It is opened, i.e., pressed outwards, by the pressure of the filling substance. As a result, it releases a larger part or the entire opening cross section. This mobility of the flap is achieved with a hinge, for example, a film or elastomer hinge (see below). In the variant “flap”, the exit opening is preferably covered by precisely one flap, which is further preferably movable about precisely one hinge.

According to a preferred embodiment, the flap is formed from a hard plastic, cf. the above particulars with respect to possible materials and degrees of hardness. This variant is preferably combined with the hard plastic sleeve body, wherein the flap and the sleeve body are preferably formed from the same hard plastic.

In a preferred embodiment, the hard plastic flap is connected to the hard plastic sleeve body via a hard plastic film hinge and these hard plastic parts are monolithically with one another. “Monolithically” means, without interruption, continuously from the same plastic material, i.e., without a material boundary therebetween. These hard plastic parts can preferably be injection molded as one component. The bushing sleeve overall can be a single-component injection-molded part, but also a multi-component injection-molded part (in which, for example, a seal or the like from a soft component can be injection-molded onto the said hard plastic parts).

If reference is made in the present case in general to a “multi-component part”, this preferably has a hard plastic component and a soft plastic component. The components are preferably in one piece with one another (non-destructively separable), which can generally also be achieved, for example, by adhesive bonding or vulcanization. It is preferably a multi-component injection-molded part.

According to a preferred embodiment which relates to a multi-component bushing sleeve, a sealing element which is assigned to the exit opening is molded from the soft component. In the first state, the flap preferably bears against or with the sealing element, that is to say seals the flap against the sleeve body. If the flap is then pressed outwards by the filling substance, it is lifted off the sealing element or the flap together with the sealing element is lifted off the sleeve body. The sealing element can extend circumferentially at the full end or else only partially around the exit opening. It does not necessarily have to create a complete seal in the first state, but rather can also facilitate, for example, a resilient lifting off during opening of the flap.

As an alternative to the hard plastic film hinge, the flap can also be mounted on the sleeve body via an elastomer hinge (made from a soft plastic, see below with respect to possible details). In the case of the hard plastic flap, it can be produced, for example, with the elastomer hinge as a two-component injection-molded part and assembled with a hard plastic sleeve. The soft component forming the elastomer hinge can in this case sit, for example, in a form-fitting manner in the opening in the sleeve body, for example, like a lamella plug, and carry the cover centrally. Alternatively, however, the cover, sleeve body and elastomer hinge can also be injection-molded, for example, as a multi-component part, optionally additionally with a seal described above.

In an embodiment which is preferred as an alternative to the hard plastic flap, it is provided from a soft plastic. The Shore hardness (Shore A) thereof can be, for example, at most 90 Shore, 80 Shore, 75 Shore, or 70 Shore and (independently thereof), for example, at least 20 Shore, 25 Shore, 30 Shore, 35 Shore, or 40 Shore. It can be, for example, a rubber material, preferably a synthetic rubber, for instance EPDM (ethylene-propylene-diene, M group). However, it can also be, for example, a thermoplastic elastomer (TPE) or a silicone-based material, for instance silicone rubber or silicone elastomer.

In combination with the hard plastic sleeve body, the soft plastic flap can make good filling substance distribution outside possible despite the good pushability of the bushing sleeve or good forwarding of the filling substance in the interior. In general, assembly is also possible, that is to say, for example, a lamella plug corresponding to the opening in the sleeve body with a central flap can be inserted into the opening in the sleeve body. It is preferably a multi-component injection-molded part, that is to say, for example, the flap is injection-molded as a soft component onto the sleeve body as a hard component.

In general, according to a preferred embodiment, a covering portion made from a soft plastic (see above) is provided which at least partially covers the exit opening in the first state and, in the second state, exposes an enlarged opening cross section. In general, this covering portion can also be the soft plastic flap just discussed, that is to say, it can be movable (foldable) about a hinge. However, such a foldability is not compulsory; the covering portion can also be connected to the sleeve body, for example, via a longer connecting line which by itself no longer acts as a folding hinge. In general, the covering portion can also be connected via a completely circumferential connecting line and, for example, be designed as such a thin membrane that it tears open under the pressure of the filling substance.

In a preferred embodiment, the connecting line of covering portion and sleeve body extends partially, but not completely, around the exit opening (for example, over at least 40%, 50%, or 60% of the opening circumference, but over no more than 90% or 80%). Thus, there is some space and also mobility in the covering portion itself, so that it can be pressed outwards by the filling substance, i.e., assumes a tent or dome shape open on one side under the pressure. This is open facing away from the connecting line; the filling substance can flow out in this direction.

According to an alternatively preferred embodiment, the soft plastic covering portion is divided with a plurality of parting lines. These can already be separated in the first state; alternatively, however, a relatively thin material bridge can also be formed there, for example, which serves as a predetermined breaking point. When viewed in a plan view, for example, looking radially thereon (with respect to the center axis of the bushing sleeve), the parting lines can intersect at an intersection point and thus divide the covering portion circumferentially around the exit opening into multiple tongues. These are, at least in the second state, self-supporting at the intersection point (and suspended at the edge). These free ends are pressed outwards by the filling substance and in the process also away from one another (which results in the widened cross section). Preferably, two parting lines are provided which intersect at a central intersection point. The covering portion is thus divided into four tongues.

The parting line or lines can generally be introduced, for example, subsequently, for example, punched in (for example, with a star-shaped punching tool). However, they are preferably already taken into account in the molding tool of the soft plastic covering portion, for example, via correspondingly thin webs, for example, from a metal sheet. Alternatively, the molding tool can also define the tongues in planes which are offset with respect to one another with respect to the radial direction. By an offset between clamping tongues which are closest adjacent circumferentially around the exit opening, an at least reduced material thickness or else an already original separation is respectively achieved there. If, for example, a total of four tongues are provided (see above), the mutually opposite tongues can respectively lie in the same plane and the closely adjacent tongues can lie in offset planes. Also independently of how the parting lines are introduced in detail, the corresponding covering portion can generally be produced as a separate part and assembled with the sleeve body (for example, as a lamella plug); however, it is preferably a multi-component injection-molded part.

According to a preferred embodiment, the exit opening has a shape which is elongated in the axial direction. It is thus, respectively with respect to the center axis of the bushing sleeve, longer in the axial direction than wide in the circumferential direction; the length can be, for example, at least 1.5, 2, 3, 4, 5, 6, 7, 8, 9, or 10 times the width (with possible upper limits at, for example, at most 500, 300, 100, 80, 60, 50, 40, 30, or 20 times). In this case, a plurality of axially elongated exit openings can be provided circumferentially distributed; in this case, there can also be respectively only one single exit opening axially.

If, for example, a certain handling outlay is required in production (for example, punching in parting lines and/or inserting a soft plastic covering portion or a flap, etc., cf. the above possibilities), the openings which are provided in an elongated manner but in a limited number can help to reduce the processing outlay. However, the elongated shape can also help, for example, in an injection molding production, for example, a soft plastic flap and/or a soft plastic hinge, to reduce the outlay in the tool production or during demolding or in a subsequent inspection/process control. Particularly preferably, the elongated exit opening can be provided with a correspondingly elongated flap, the hinge axis of which is preferably parallel to the center axis of the bushing sleeve. In the second state, the elongated flap can be open further, for example, in a portion of the supply volume which is proximal to the filling substance injection than in a portion which is distal thereto (the proximal portion can lie, for example, closer to a flange part of the line bushing than the distal portion).

Also independently of the type of covering in detail, the elongated exit opening can preferably be provided in such a way that the width which is taken in the circumferential direction increases into the passage opening. In an axial portion of the supply volume which the filling substance first passes during the injection, the width which is taken in the circumferential direction about the center axis of the bushing sleeve is therefore smaller than in an axial portion which is subsequently passed by the filling substance. Therefore, if the viscosity of the filling substance increases with increasing time, filling substance can still penetrate into the filling volume on account of the exit opening which is larger deeper in the passage opening.

This concept can also be realized independently of the elongated exit opening, namely with a plurality of axially successive exit openings in which the pressure which is necessary for the automatic opening from the first state into the second state and/or the opening cross section which is available in the second state is set differently. The pressure which is respectively necessary for the opening can decrease into the passage opening and/or the opening cross section which is respectively available in the second state can increase.

As mentioned before, the line itself (for example, the glass fiber cable) could generally also be foamed in together with the bushing sleeve (the line would therefore delimit the supply volume together with the bushing sleeve). However, the bushing sleeve preferably delimits the supply volume together with an empty pipe through which the line can then, for example, also be laid only later. The empty pipe can have, for example, an outer diameter of at least 5 mm and, for example, not more than 20 mm, in particular not more than 15 mm. Particularly advantageous outer diameters can be, for example, 7 mm, 10 mm, and 12 mm, wherein the installation technician can select a corresponding empty pipe on site and guide it with the filling substance through the bushing sleeve before it is fastened. In this case, the bushing sleeve can be inserted, for example, into the passage opening; however, the sleeve and the empty pipe can also be inserted together.

The filling substance can be supplied to the supply volume, for example, via a filling tube which is inserted axially into the supply volume. Alternatively, the filling substance can also be introduced, for example, via a filling opening in the jacket wall of the bushing sleeve, wherein this filling opening is preferably located outside the passage opening. In particular, the filling opening can be arranged on one axial side of a flange part (see below) and the exit opening(s) can be arranged on the other axial side of the flange part.

In a preferred embodiment, the line bushing has a flange part which, when the bushing sleeve is inserted into the passage opening, is brought into abutment against the side face of the wall or floor element. This can create, for example, a stop for the insertion, i.e., can fix the bushing sleeve in a defined assembly position for the subsequent filling substance supply. The flange part can preferably extend completely circumferentially around the passage opening; it can thus also assume a sealing function, for example. A flange part of comparatively thin-walled design can be preferred in the axial direction, because good pressing can thus be possible even in the case of unevenness in the side face (for example, structural plaster, breakouts, etc.). The thickness can be, for example, at most 10 mm, 8 mm, 6 mm, 5 mm, or 4 mm (with possible lower limits of at least 1 mm or 2 mm).

A bitumen or butyl band is preferably arranged on that side of the flange part which is pressed against the side face. This preferably has a flat configuration, i.e., is thinner in the axial direction than in the radial direction when viewed in an axial section containing the center axis (wherein only a respectively cohesive part of the sealing band is viewed in the section, which thus lies on one side of the center axis in the section). The radial dimension can be, for example, at least 2 or 3 times the axial dimension (possible upper limits are, for example, at most 15 or 10 times). Independently of these details, the flat configuration can easily allow pressing, in particular in conjunction with the thin-walled flange part.

According to a preferred embodiment, the exit opening is provided in such a way that the filling substance exits with a directional component which points towards the flange part. This will typically be superimposed with a radial directional component, so that the filling substance flows obliquely outwards in the direction of the flange part, i.e., out of the bushing sleeve. For this purpose, the exit opening can itself sit tilted in the bushing sleeve, that is to say in an obliquely set portion of the jacket wall thereof. Alternatively, however, for example, the jacket wall per se can also be straight when viewed in an axial section containing the center axis; however, the exit opening can be the mouth of a channel passing obliquely through the jacket wall. Furthermore, for example, the automatically opening covering mechanism can also define a direction towards the flange part, that is to say, for example, the hinge of a flap can lie on the side of the exit opening facing away from the flange part, so that the flap opens towards the flange part and the filling substance correspondingly flows out. The mechanisms can of course also be combined with one another. The outflow direction of the filling substance, which results as an average value of individual outflow directions, that is to say, the direction of the center of gravity, can enclose, for example, an angle of at least 10°, 20°, or 30° and of at most 80°, 70°, or 60° with the center axis of the bushing sleeve.

Preferably, a plurality of exit openings provided circumferentially and/or axially successively are respectively designed for a filling substance release directed in the direction of the flange part (and the filling substance flows out correspondingly during assembly). In general, the directed release can be advantageous to the effect that the bushing sleeve is therefore pulled reliably into its abutment against the side face a little into the passage opening or the flange part. Although a combination with the automatic opening is preferred, the directed release is also intended to be disclosed independently of the automatically opening exit opening(s), that is to say, for example, also in combination with an exit opening which can be provided in particular in a hard plastic sleeve body, and the opening cross section of which remains unchanged during the filling substance release. In other words, the automatically openable design in the case of an exit opening designed for the directed release is then an option, but not mandatory. In combination with the automatic opening, however, the implementation can be particularly simple (for example, flap or dome).

The flange part can be produced separately from the bushing sleeve and subsequently assembled therewith, in particular in the case of a hard plastic sleeve body and soft plastic flange part. Alternatively, however, these hard and soft components can also be produced as a multi-component injection-molded part. However, the flange part can also be provided from a hard plastic; it is then preferably formed monolithically with the hard plastic sleeve body.

The bushing sleeve and the flange part are preferably tiltable relative to one another, that is to say, an angle can be set between the center axis of the bushing sleeve and a surface normal which is perpendicular to a plane defined by the abutment of the flange part (in the mounted state, this plane lies parallel to the side face of the wall or floor element or coincides therewith). The tiltability can extend, for example, from 0° (untilted/parallel) to at least 10°, 20°, or 30°, wherein possible upper limits can be 70°, 60°, or 50°. In general, the articulated mounting can also be realized with joint faces which slide against one another during the tilting (for example ball joint).

However, a joint sleeve is preferably provided which is compressed on a radial side during tilting and is expanded on the radially opposite side (the center axis is tilted toward the former, it is tilted away from the latter). The joint sleeve can be formed with a plurality of successive projections and indentations which can, for example, respectively be circumferentially closed in itself. When viewed in an axial section containing the center axis, the projections, between which one indentation is provided respectively, can follow one another radially and/or axially. In the case of an axially successive arrangement, in general all projections (and indentations) can be arranged on that side of the flange part which abuts against the side face in the mounted state. The projections and indentations can therefore be inserted into the passage opening during assembly.

The flange part can be provided with the axially successive projections/indentations, but also in a central region thereof, i.e., at an axial position between the axially outermost projections, with respect to the axial extent of the joint sleeve. Therefore, there are also one or more projections/indentations outside the passage opening, the joint sleeve can therefore also describe a curvature there. This can simplify the laying of the line/of the empty pipe, in particular in the ground or in generally poorly accessible locations, etc. An angling of this portion arranged outside the passage opening can, however, offer advantages, for example, with regard to the filling substance supply.

The joint sleeve can be provided from a soft plastic, cf. the above particulars with respect to possible materials and hardnesses. Alternatively, however, a correspondingly thin-walled hard plastic can also form the joint sleeve (in principle comparable to a straw). The joint sleeve and the flange part are preferably molded monolithically from the same material. Independently of their configuration in detail, the joint sleeve via which the bushing sleeve and the flange part are tiltable relative to one another is also intended to be disclosed independently of the automatically opening exit opening according to the main claim. The line bushing equipped with the joint sleeve can then therefore optionally be provided with an automatically opening exit opening, but the automatic opening is not mandatory (the exit opening could generally also have an unchanged flow cross section). Otherwise, the bushing sleeve, the flange part and/or the joint sleeve can then optionally be configured in a manner described above.

The invention is explained in more detail below on the basis of exemplary embodiments, wherein the individual features within the scope of the coordinated claims can also be essential to the invention in a different combination and also furthermore are not separated in detail between the different claim categories.

Parts of the invention can also be summarized in the form of the following aspects:

1. Aspect: Use of a line bushing,
which has a bushing sleeve, through which a line can be guided along a center axis of the bushing sleeve,
wherein an exit opening is provided in the bushing sleeve, which exit opening, in an open, second state, connects a supply volume arranged on the inside of the bushing sleeve to a filling volume arranged on the outside of the bushing sleeve, for installation in a passage opening in a wall or floor element of a building,
wherein
i) the bushing sleeve is inserted into the passage opening, and
i) a flowable filling substance is supplied to the supply volume of the bushing sleeve, which flowable filling substance penetrates at least proportionally into the filling volume via the exit opening,
wherein the exit opening is in a first state in step i) and is brought into the second state under the pressure of the flowable filling substance in step ii), in which second state an opening cross section of the exit opening is greater than in the first state.

2. Aspect: Use according to aspect 1, in which at least one sleeve body of the bushing sleeve is formed from a hard plastic.

3. Aspect: Use according to aspect 1 or 2, in which the exit opening is at least partially covered by a flap in the first state.

4. Aspect: Use according to aspects 2 and 3, in which the flap is also formed from the hard plastic.

5. Aspect: Use according to aspect 4, in which the flap is monolithically connected to the sleeve body via a film hinge, which is also formed from the hard plastic.

6. Aspect: Use according to aspect 4 or 5, in which the bushing sleeve is a multicomponent part, wherein a sealing element, which seals the flap against the sleeve body in the first state, and/or an elastomeric joint of the flap is formed from a soft plastic.

7. Aspect: Use according to aspect 3, in which the flap is formed from a soft plastic.

8. Aspect: Use according to aspect 1 or 2, in which a covering portion, which at least partially covers the exit opening in the first state, is formed from a soft plastic.

9. Aspect: Use according to aspect 8, in which the covering portion is connected along a connecting line which runs partially, but not completely, around the exit opening, wherein the covering portion is raised in a dome-shaped manner by the filling substance in the second state and at least partially exposes the exit opening.

10. Aspect: Use according to aspect 8, in which the covering portion is divided circumferentially into a plurality of tongues which, when viewed in a plan view, run together at an intersection point, specifically respectively towards their free end, wherein the free ends are pressed apart by the filling substance in the second state.

11. Aspect: Use according to one of the preceding aspects, in which the exit opening has a shape which is elongated in the axial direction of the bushing sleeve.

12. Aspect: Use according to aspect 11, in which the exit opening, at least in the second state, has a smaller opening width than in the first state in a portion on the supply side, into which filling substance first penetrates in step ii).

13. Aspect: Use according to one of the preceding aspects, in which the line bushing has a flange part which, in step i), is brought into abutment against a side face of the wall or floor element.

14. Aspect: Use according to aspect 13, in which the filling substance exits from the exit opening in step ii) with a directional component which points towards the flange part.

15. Aspect: Use according to aspect 13 or 14, in which the flange part and the bushing sleeve are tiltably mounted relative to one another via a joint sleeve.

The invention is explained in more detail below on the basis of exemplary embodiments, wherein the individual features within the scope of the coordinated claims can also be essential to the invention in a different combination and also furthermore are not separated in detail between the different claim categories.

In detail:

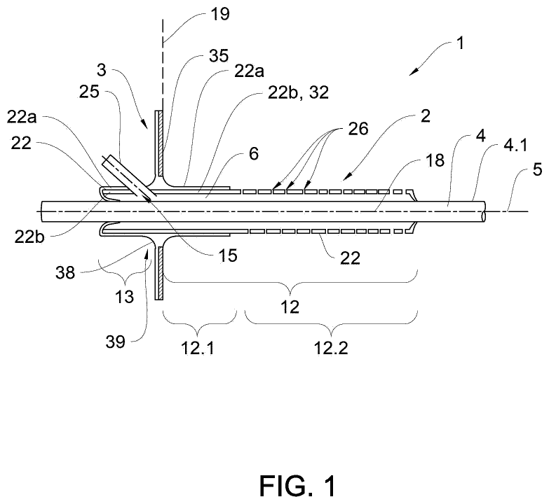

FIG. 1 a first line bushing;

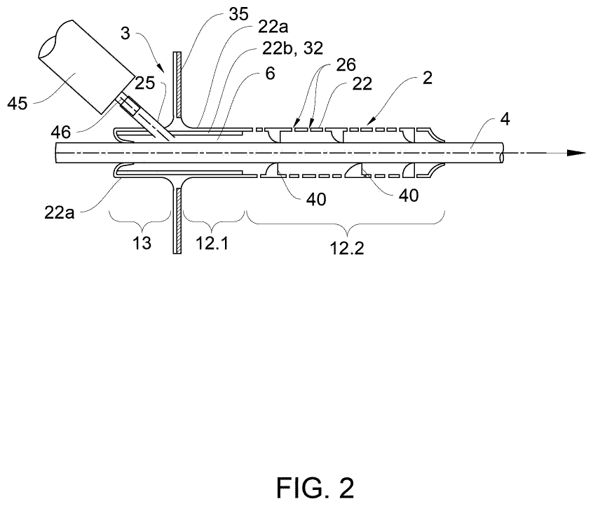

FIG. 2 a second, alternatively configured line bushing;

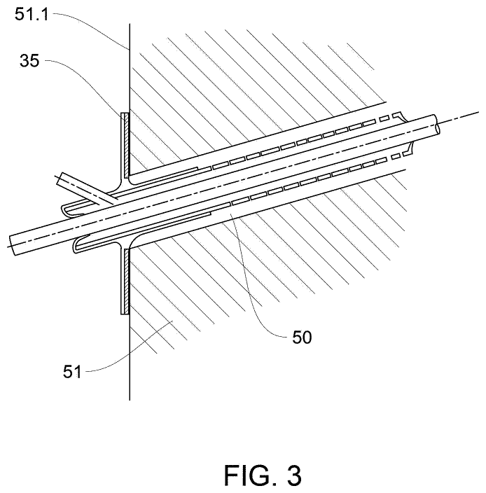

FIG. 3 an illustration of the first line bushing according to FIG. 1 in an assembly situation;

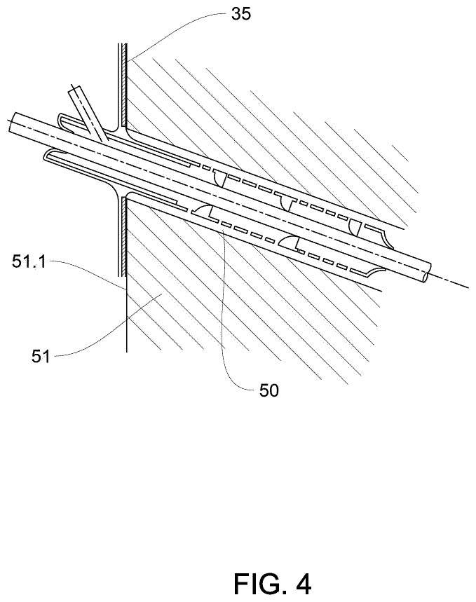

FIG. 4 an illustration of the second line bushing according to FIG. 2 in an assembly situation;

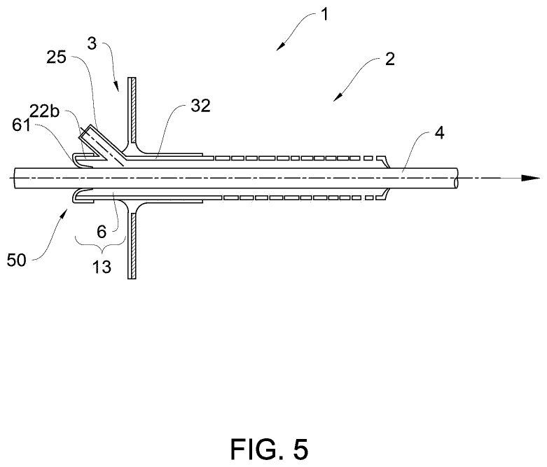

FIG. 5 a third line bushing;

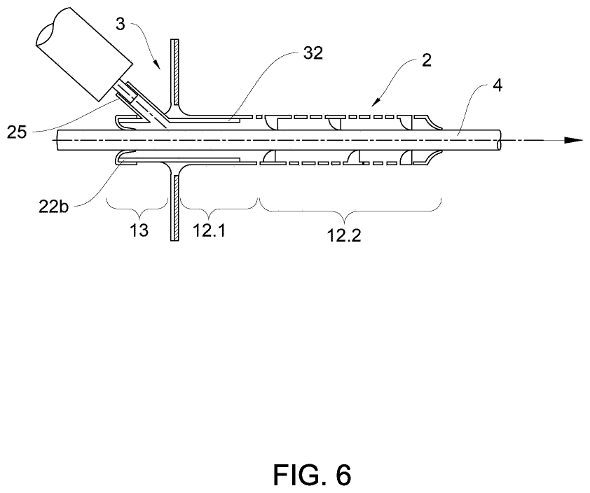

FIG. 6 a fourth line bushing;

FIG. 7 a fifth line bushing;

FIG. 8 a sixth line bushing;

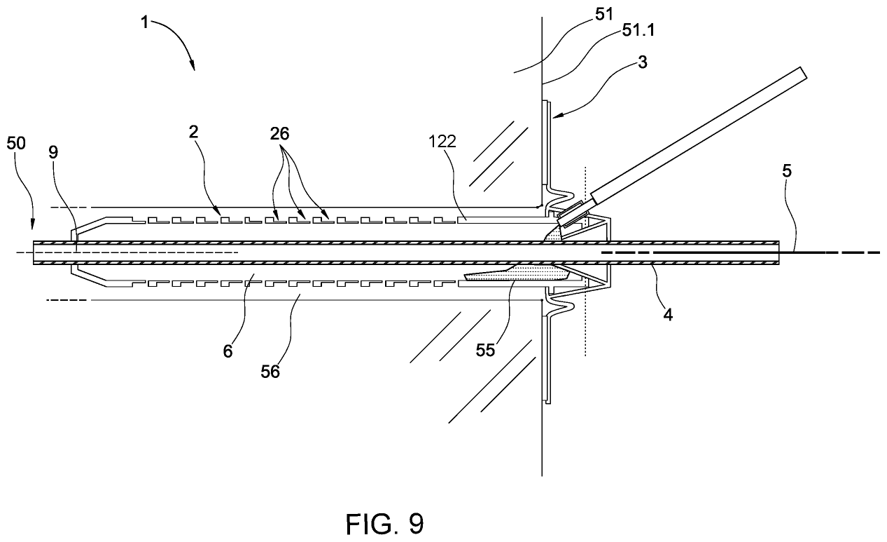

FIG. 9 a further line bushing with a bushing sleeve;

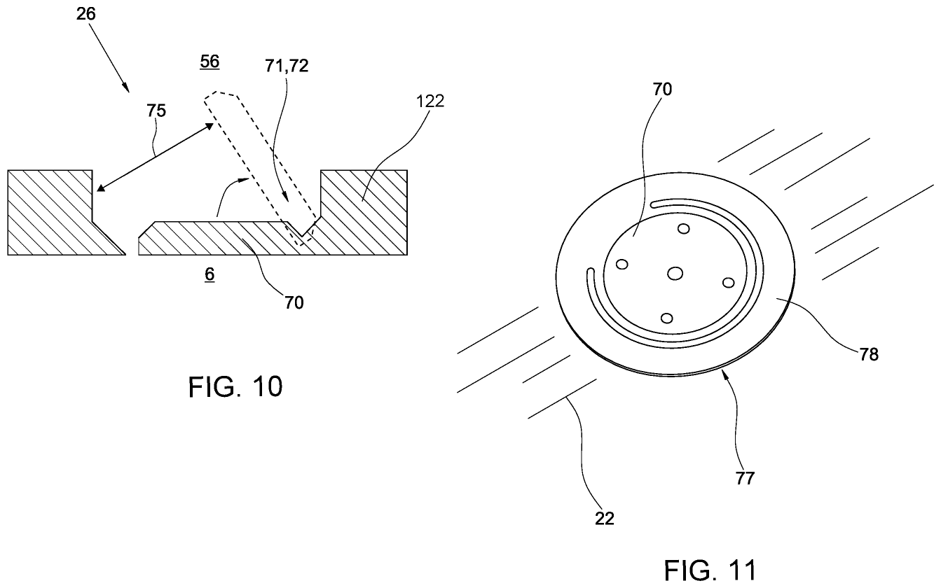

FIG. 10 an automatically openable exit opening in the bushing sleeve according to FIG. 9 in a detailed view;

FIG. 11 an alternative possibility to the injection molding for implementing an automatically opening flap;

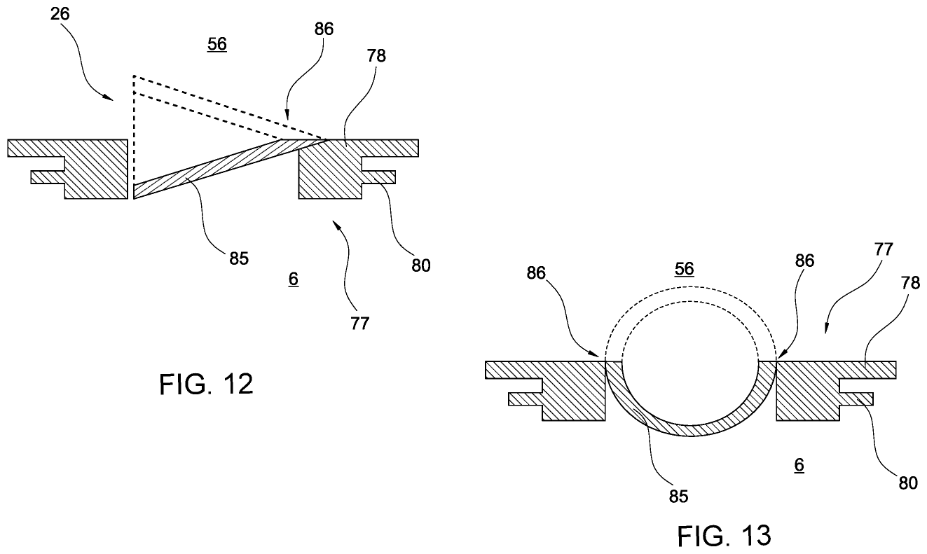

FIG. 12 a soft plastic covering portion which opens in a dome-shaped manner under pressure as an alternative to a flap;

FIG. 13 the soft plastic covering portion according to FIG. 12 in a view rotated through 90°;

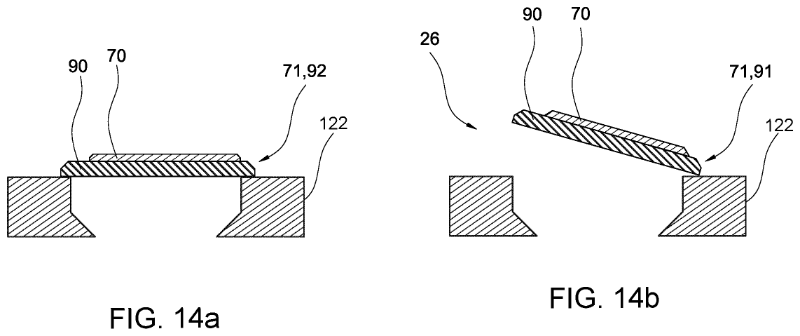

FIG. 14a, b a flap with a seal as an alternative to the variant according to FIG. 10 in the closed and open state;

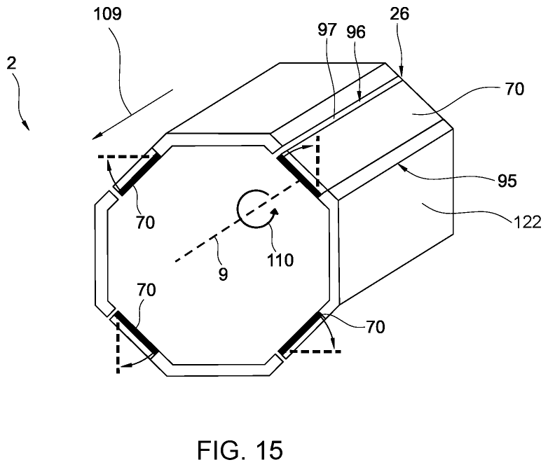

FIG. 15 a bushing sleeve in a schematic illustration, with axially elongated exit openings in the jacket wall;

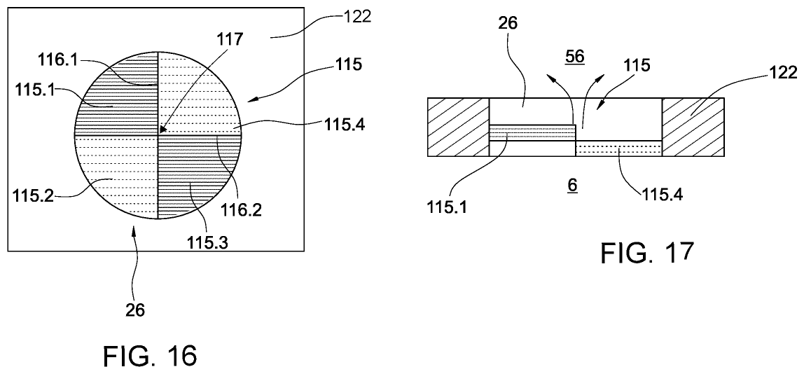

FIG. 16 a soft plastic covering portion which is divided into tongues with parting lines;

FIG. 17 the covering portion according to FIG. 16 in a sectional side view;

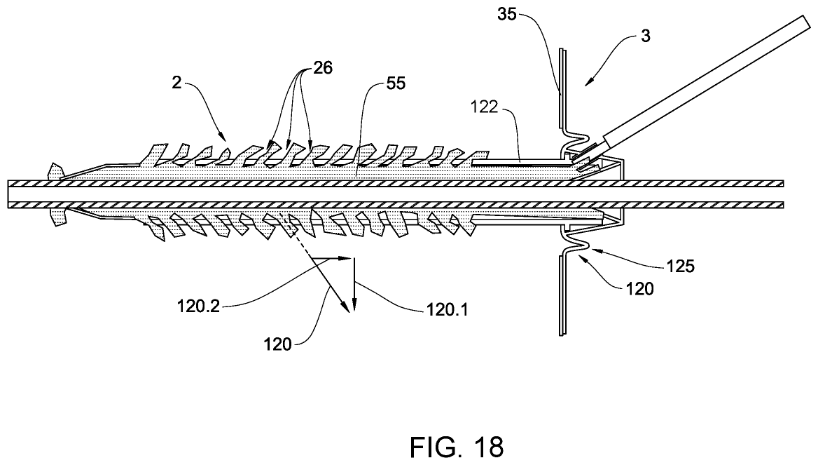

FIG. 18 a line bushing with exit openings designed for the directed filling substance release in the bushing sleeve;

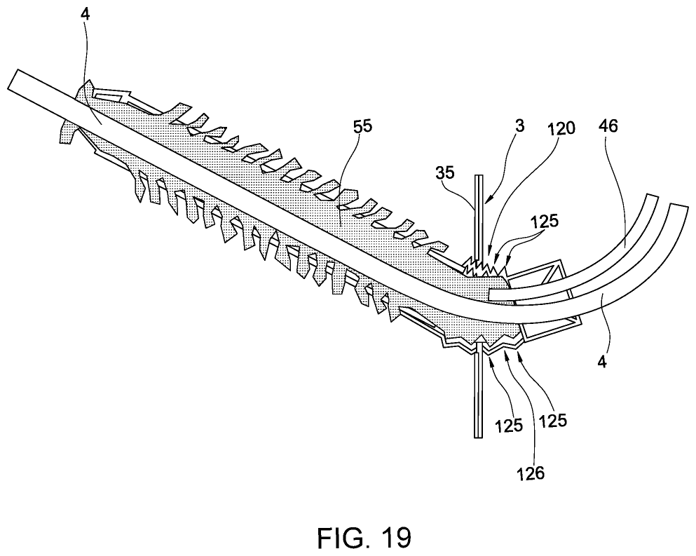

FIG. 19 a line bushing with a joint sleeve.

FIG. 1 shows a line bushing 1 which has a bushing sleeve 2 and a flange part 3. An empty pipe 4 is led through the bushing sleeve 2, in which the actual line 5, in the present case a glass fiber cable, can then be later laid. The bushing sleeve 2 is divided into an insertion portion 12, which is inserted into a passage opening (see below), and an injection portion 13, which then projects out of the passage opening. Together with the empty pipe 4, specifically its outer wall surface 4.1, the bushing sleeve 2 delimits an annular space 6. In the injection portion 13, a filling opening 15 is provided in a jacket wall 22 of the bushing sleeve 2, which jacket wall delimits the annular space 6 radially outwards, via which filling opening a filling substance, in particular a PU-based injection resin, can be supplied to the annular space 6.

The jacket wall is constructed in several layers in the injection portion, namely from a layer 22a of an elastomer material and a layer 22b of a hard plastic. A connecting piece 25, to which an injection cartridge can be connected (cf. also FIG. 2 for illustration), is integrally formed monolithically with the layer 22a. The connecting piece 25 opens obliquely into the annular space 6 at the filling opening 15, the filling substance supplied outside the passage opening is thus injected with a directional component into the insertion portion 12, i.e., into the passage opening.

The insertion portion 12 is divided into a first axial portion 12.1 and a second axial portion 12.2; in the latter, the bushing sleeve 2 is provided with a plurality of outlet openings 26. The filling substance can emerge from these and be placed against a frame of the passage opening. In contrast, the jacket wall 22 is closed in the first axial portion 12.1, which facilitates the forwarding of the filling substance. There, the bushing sleeve 2 is constructed in several layers as in the injection portion 13; the rigid layer 22b is formed by a support sleeve 32. In the present case, the support sleeve extends continuously beyond the portions 13, 12.1, and 12.2, wherein it is provided with the outlet openings 26 in the second axial portion 12.2.

The layer 22a formed from the elastomer material extends monolithically over the injection portion 13 and the first axial portion 12.1; furthermore, the flange part 3 or the elastomeric layer thereof is also integrally formed monolithically from the elastomer material. The elastic flange part 3 can be pressed easily; on one side thereof, it has a flat bitumen band 35. An elastomeric deformation element 38, which serves as a joint 39, is formed from the elastomer material between the flange part 3 and the bushing sleeve 2. As a result, the elastomeric sleeve 2 can be tilted relative to the flange part 3, that is to say, its center axis 18 can be tilted relative to a plane 19 defined by the flange part 3.

FIG. 2 shows a line bushing 1 which is configured alternatively in parts, wherein primarily the differences from the above variant are discussed below. In general, within the scope of the present disclosure, the same reference symbols relate to parts with the same or comparable function and in this respect reference is also always made to the description of the respectively other figures. In the variant according to FIG. 2, the injection portion 13 is constructed analogously to FIG. 1, and the insertion portion 12 is also divided into two axial portions 12.1, 12.2.

In contrast to FIG. 1, however, the jacket wall 22 in the second axial portion is not formed by the rigid material of the layer 22b, but rather by the elastomer material. This jacket wall 22 of the second axial portion 12.2 is formed monolithically with the layer 22a of the first axial portion 12.1 and injection portion 13. In the second axial portion 12.2, the expansion of the filling substance, unlike in the first axial portion 12.1, is not limited by the support sleeve 32; as a result, the flexible jacket wall 22 is pressed radially outwards by the filling substance. In order to keep the outlet openings 26 for the filling substance easily accessible despite this flexible configuration, spacers 40 are integrally formed on the inside of the jacket wall, which spacers keep the jacket wall 22 defined around the empty pipe 4. FIG. 2 furthermore illustrates the application of a resin cartridge 45, the injection connecting piece 46 of which can be inserted into the connecting piece 25 of the elastomer sleeve 2.

FIGS. 3 and 4 each illustrate an assembly step preceding the injection of the filling substance; the respective line bushing 1 is inserted into a respective passage opening 50, in particular a hole, in a respective wall or floor element 51 (in the present case a wall). The flange part 3 abuts flat against the side face 51.1 via the butyl band 35. The passage opening 50 is not perpendicularly to this side face 51.1, but tilted. This tilting is also set for the bushing sleeve 1 with the joint 39 formed from the elastomer material; the bushing sleeve is tilted correspondingly to the flange part 3 via the joint 39.

FIG. 5 shows a line bushing 1 which is provided analogously to the variant according to FIG. 1 with a jacket wall which is rigid in the second axial portion 12.2. In contrast to FIG. 1, the elastomer material from which the layer 22a in the first axial portion and the flange part 3 are formed does not extend continuously into the injection portion 13. A sealing collar 61 from the elastomer material is nevertheless arranged at its axial end 50, as in the above variants. This sealing collar closes off the annular space 6 towards the axial end 15, that is to say prevents filling substance from exiting. The sealing collar 61 can be pulled onto the support sleeve 32 as a separate part, but it can likewise be injection-molded as a soft component during production as a multi-component injection-molded part.

The variant according to FIG. 5 furthermore differs from the above embodiments to the effect that the connecting piece 25 is not formed monolithically from the elastomer material, but rather monolithically with the support sleeve 32 from the hard plastic. This applies analogously to the variant according to FIG. 6, in which the injection portion 13 and the first axial portion 12.1 are designed as in the variant according to FIG. 5, but the second axial portion 12.2 corresponds to the embodiment according to FIG. 2.

FIG. 7 shows a line bushing 1, the bushing sleeve 2 of which is provided with exit openings 26, schematically during foaming. The exit of the filling substance 55 from the individual exit openings 26 can therefore be seen. In this case, the filling substance 55 respectively exits in a directed manner, i.e., per exit opening 26 with a direction 120 which, in addition to a radial directional component 120.1, has a directional component 120.2 towards the flange part 3. This is therefore pulled well into abutment against the wall (not illustrated here). The directed filling substance exit can be achieved, for example, by channels forming the exit openings 26 respectively passing obliquely through the jacket wall 22, which is designed to be rigid here, in the direction of the flange part 3.

The flange part 3 is connected to the bushing sleeve 2 via an elastomeric joint 39, for which purpose a jacket wall of the joint 39 is formed with a projection 125 which creates play. In the present case, the flange part 3 and the joint 39 are formed monolithically with one another from a soft plastic and assembled with the bushing sleeve 2. The flange part 3 is of comparatively thin-walled design, which allows good pressing against the side face of the wall or floor element (cf. FIG. 1 for illustration). The flange part 3 can in principle be pressed against the side face and fastened thereto like an adhesive or fabric band via a butyl band 35 of large surface area.

FIG. 8 shows a variant which is alternative to FIG. 7 with regard to the realization of the tiltability, wherein reference is made to the above statements with respect to the other features. The jacket wall of the elastomeric joint 39 is also formed with a projection 125, wherein, in this example, a plurality of projections 125 are arranged axially successively with a respective indentation 126 in between.

FIG. 8 illustrates a curved line laying, for which purpose the projections 125 are compressed toward one another on the one side (at the top in FIG. 8) and are expanded away from one another on the opposite side (at the bottom in FIG. 8). In this case, the flange part 3 is arranged at an axially central position of the joint 39 (formed monolithically therewith), so that a curved line routing is also possible in a portion thereof lying outside the passage opening. The tilting possibility outside the passage opening can be of interest not only with regard to a curved laying of the empty pipe 4, but also in the positioning of the injection connecting piece 46 via which the filling substance 55 is supplied.

FIG. 9 shows a line bushing 1 which has a bushing sleeve 2 and a flange part 3. An empty pipe 4 is led through the bushing sleeve 2, in which the actual line 5 (only indicated schematically) can then be later laid, in the present case a glass fiber cable. During the assembly of the line bushing 1, the bushing sleeve 2 is inserted into a passage opening 50 in a wall or floor element 51, in the present case into a hole in a wall. In this case, the flange part 3 comes into abutment against the side face 51.1 of the wall or floor element 51.

For fastening and also sealing the bushing sleeve 2, a filling substance 55, typically a two-component (2K) expansion resin, in particular PU-based, is supplied to a supply volume 6 which delimits the bushing sleeve 2 together with the empty pipe 4. The filling substance 55 is initially still comparatively liquid, wherein an uncontrolled running-out of the filling substance 55 is prevented with the bushing sleeve 2 and the supply volume 6 delimited thereby. The bushing sleeve 2, specifically its sleeve body 122, is provided from a hard plastic (for example ABS), which can simplify the insertion even in the case of small drill hole diameters and, in particular, can result in good forwarding of the filling substance 55 axially into the passage opening 50. In simplified form, the supply volume 6 is delimited comparatively rigidly in this initial phase and the filling substance 55 is introduced deep into the opening, that is to say to the left in FIG. 9.

A plurality of exit openings 26 are provided in the bushing sleeve 2 in order to connect the supply volume 6 to a filling volume 56 arranged on the outside of the bushing sleeve 2. These are designed to open automatically, namely are largely closed in a first state illustrated here (cf. in particular also the following detailed illustrations). The initially relatively liquid filling substance is thus held together. However, if the filling substance 55 has spread out axially (cf. also FIGS. 17 and 18 for illustration) and the pressure in the supply volume 6 increases, in particular as a result of the chemical reaction of the filling substance, the openings 26 pass into a second state, in which they have a larger opening cross section. The filling substance 55, the viscosity of which increases over time, can thus emerge easily into the filling volume 56, the bushing sleeve 2 is foamed reliably into the passage opening 50.

FIG. 10 shows an exit opening 26 in a detailed view, namely when viewed in a sectional plane containing the center axis 9 of the bushing sleeve 2. A detail of the sleeve body 122 can be seen, wherein a cover 70 is formed monolithically therewith, i.e., from the same continuous hard plastic material. The cover 70 is mounted on the sleeve body 122 via a hinge 71, which in the present case is formed as a film hinge 72 (made from the hard plastic material). If a pressure acts on the cover 70 from the inside, i.e., from the supply volume 6, the cover is lifted off a little (illustrated by dashed lines), that is to say, an opening cross section 75 which is available for the outflow of the filling substance is increased. In the example according to FIG. 10, the cover 70 and the sleeve body 122, and also the film hinge 72 as a region of reduced material thickness, are injection molded as a hard component in one pass, the bushing sleeve 2 can be a single-component or else a multi-component injection-molded part (for example, the flange part 3 could be injection-molded as a soft component).

FIG. 11 illustrates an alternative possibility for the implementation of a flap 70 which, in contrast to that according to FIG. 10, is not formed monolithically with the sleeve body 122 which is only indicated schematically here in a plan view, but rather is used as a separate part. The flap 70 is part of a lamella plug 77 which additionally has a circumferential collar 78 on the outside. This collar 78 is pressed into an opening in the sleeve body 122, the lamellas then holding it in the opening in a form-fitting manner, cf. FIG. 4 for illustration.

FIG. 12 shows another lamella plug 77 in an axial section, that is to say firstly illustrates the collar 78 with the lamella or lamellas 80 (only one is illustrated here for the sake of clarity). This creates or create a frictional or preferably form-fitting support when inserted into the opening in the sleeve body 122. FIG. 13 shows the same lamella plug 77 in a sectional plane rotated through 90°, that is to say perpendicular to the center axis 9. The covering mechanism differs from the variants discussed hitherto, wherein a corresponding exit opening 26 can also be integrated independently of the implementation as a lamella plug 77, that is to say, for example, can be injected into a sleeve body 122 from hard plastic as a soft component.

Independently of the implementation (lamella plug or two-component injection-molded part), a covering portion 85 from a soft plastic, for example TPE, is provided in this variant. Here, a connecting line 86, along which the covering portion 85 is connected to the collar 78 or sleeve body 122, is closed circumferentially partially, but not completely, around the exit opening 26. This covering portion 85 is illustrated hatched in the first state, it is, as it were, turned downward and largely covers the exit opening 26. If an increasing pressure is built up by the filling substance in the supply volume 6, the covering portion 85 can finally be turned outwards on account of its elastic deformability, cf. the dashed illustration. It then spans the exit opening 26 in a dome-shaped manner and releases the exit of the filling substance, to the left in FIG. 4.

FIGS. 14a, b illustrate a further variant, namely a cover 70, which is additionally provided with a seal 90. In the present case, the seal 90, for example from TPE, is provided in one piece with the cover 70 from hard plastic, for example ABS. The two can be produced jointly as a multi-component injection-molded part, wherein they can be assembled with the sleeve body 122 or else the latter can be produced in the same injection molding operation (as a hard component). One possibility for production can go, for example, to the effect that, after removal from the molding tool, the seal 90 is still connected completely circumferentially to the sleeve body 122 and is subsequently partially detached with a punching or cutting tool. The remaining connecting region can then simultaneously serve as a hinge 71, specifically as an elastomer hinge 91.

FIG. 15 shows schematically a bushing sleeve 2 which is produced as a two-component injection-molded part. The sleeve body 122 is provided from a hard plastic; flaps 70 which create automatic openability are injection-molded from a soft plastic. Here, the flaps 70 are respectively connected along an edge 95 to the sleeve body 22 for the formation of the hinge 71 or elastomer hinge 92, by contrast, at the opposite edge 96, a parting joint 97 creates the foldout capability (indicated dashed). These parting lines 97 can be introduced subsequently or already kept free in the molding tool. The exit openings 26 are elongated in the axial direction, that is to say are dimensioned to be significantly larger than in the circumferential direction 110. Here, the exit openings 26 in reality, other than illustrated schematically here, will not extend as far as the axial ends of the sleeve body 122, but the latter will extend circumferentially in itself there (which creates stability).

FIGS. 16 and 17 illustrate a further possibility for configuring an automatically opening covering element 115, to be precise in a plan view (FIG. 8) and in a section (FIG. 9). The covering element 115 is provided from a soft plastic and completely covers the exit opening 26 in the first state. Here, however, it is divided with two parting lines 116.1, 116.2 which intersect at an intersection point 117. The parting lines 116.1, 116.2 divide the covering element 115 into four tongues 115.1-115.4. Under the increasing pressure of the filling substance in the supply volume 6, the parting lines 116.1, 116.2 open and the tongues 115.1-115.4 are pressed outwards and apart, cf. the arrows in FIG. 17 for illustration.

In a simple case, a corresponding covering element 115 could also be realized by producing an initially closed soft plastic membrane and subsequently punching in the parting lines 116.1, 116.2. However, the division can also already be realized in the injection molding tool, wherein in the present case the tongues 115.1-115.4 are formed in planes which are offset with respect to one another. Specifically, here, the closely adjacent tongues are respectively offset with respect to one another, but the mutually opposite tongues lie in the same plane. Depending on the spacing of the planes, a small material bridge can still remain between the closely adjacent tongues, which material bridge is then torn open.

FIG. 18 shows a line bushing 1, the bushing sleeve 2 of which is provided with exit openings 26, schematically during foaming. The exit of the filling substance 55 from the individual exit openings 26 can therefore be seen. In this case, the filling substance 55 respectively exits in a directed manner, that is to say per exit opening 26 with a direction 120 which, in addition to a radial directional component 120.1, has a directional component 120.2 towards the flange part 3. This is therefore pulled well into abutment against the wall (not illustrated here). The directed filling substance exit can be achieved, for example, by the hinges 71, as in the embodiment according to FIG. 9, being respectively arranged on that side of the respective flap which faces away from the flange part 3, so that the flaps open towards the flange part 3. However, for example, the covering portion 85 according to FIG. 12 can also be correspondingly oriented (so that the flange part 3 would lie on the left-hand side there) or the exit opening 26 or the channel forming it itself can be correspondingly tilted.

The flange part 3 is connected to the bushing sleeve 2 via a joint sleeve 120, so that the bushing sleeve 2 can also be inserted into a hole which is introduced obliquely (cf. FIG. 11 for illustration). For this purpose, the joint sleeve 120 is formed with a projection 125 which creates play. In the present case, the flange part 3 and the joint sleeve 120 are formed monolithically with one another from a soft plastic and the bushing sleeve or the sleeve body 122 is inserted. As an alternative to this, such a line bushing can also be provided without a sleeve body; the soft plastic of the joint sleeve can thus form the bushing sleeve 2 (for example, as in the second axial portion in FIG. 2). The flange part 3 is of comparatively thin-walled design, which allows good pressing against the side face of the wall or floor element (cf. FIG. 1 for illustration). The flange part 3 can in principle be pressed against the side face and fastened thereto like an adhesive or fabric band via a butyl band 35 of large surface area.

FIG. 19 shows a variant which is alternative to FIG. 18 with regard to the realization of the tiltability, wherein reference is made to the above statements with respect to the other features. In general, within the scope of the present disclosure, the same reference symbols refer to the same parts or parts with a comparable function and in this respect reference is also always made to the description of the respectively other figures. The joint sleeve 120 is also formed with a projection 125, wherein, in this example, a plurality of projections 125 are arranged axially successively with a respective indentation 126 in between.

FIG. 19 illustrates a curved line laying, for which purpose the projections 125 are compressed toward one another on the one side (at the top in FIG. 19) and are expanded away from one another on the opposite side (at the bottom in FIG. 19). In this case, the flange part 3 is arranged at an axially central position of the joint sleeve 120 (formed monolithically therewith), so that a curved line routing is also possible in a portion thereof lying outside the passage opening. In the present example, the flange part 3 and the joint sleeve 120 are made from a hard plastic, but in this case of comparatively thin-walled design, so that the tiltability shown is possible despite the inherently rigid material. The tilting possibility/tiltability outside the passage opening can be of interest not only with regard to a curved laying of the empty pipe 4, but also in the positioning of the injection connecting piece 46 via which the filling substance 55 is supplied.

1. A line bushing, the line bushing comprising:
bushing sleeve, through which a line can be guided along a center axis of the bushing sleeve; and
a flange part for abutting against a side face of the wall or floor element,
wherein the bushing sleeve is tiltably mounted on the flange part for changing a tilt angle,
and wherein the tiltable mounting is realized via an elastomeric deformation element as a joint,
the line bushing being configured for installation in a passage opening in a wall or floor element of a building, wherein the bushing sleeve is configured for being inserted into the passage opening in such a way that the flange part abuts against the side face of the wall or floor element.

2. The line bushing according to claim 1, wherein the bushing sleeve defines a center axis that is configured in an unloaded state to be perpendicular to a plane defined by the flange part, and the bushing sleeve is configured in use with a passage opening that is tilted relative to a surface normal on a side face, and such that the bushing sleeve is tilted relative to the flange part in the passage opening.

3. The line bushing according to claim 1, in which the joint realized as an elastomeric deformation element has a jacket wall which is formed with a circumferential projection and/or a circumferential indentation.

4. The line bushing according to claim 3, in which the jacket wall of the elastomeric deformation element extends from an inner radial position on the bushing sleeve to an outer radial position on the flange part and is formed with a circumferential projection and a circumferential indentation which follow one another radially.

5. The line bushing according to claim 3, in which at least one layer of the flange part is provided from an elastomer material, wherein the jacket wall of the elastomeric deformation element is formed monolithically with the at least one layer.

6. The line bushing according to claim 5, in which the layer of the flange part provided from the elastomer material has a thickness of at most 10 mm.

7. The line bushing according to claim 6, in which the flange part has a flat bitumen or butyl layer, the radial extent of which is thus greater than its axial extent when viewed in an axial section.

8. The line bushing according to claim 5, in which the bushing sleeve is formed monolithically with the at least one layer of the flange part from the elastomer material.

9. The line bushing according to claim 1, in which the bushing sleeve has at one end a sealing collar which extends radially inwards, and which abuts against an empty pipe guided through the bushing sleeve.

10. The method according to claim 19, in which, when an insertion portion of the bushing sleeve is inserted into the passage opening and the flange part abuts against the side face, an injection portion of the bushing sleeve, which lies on a side of the flange part axially opposite the insertion portion, projects out of the passage opening, wherein a filling opening is provided in the injection portion in a jacket wall of the bushing sleeve, via which a flowable filling substance, which then solidifies, is filled into an annular space defined by the bushing sleeve.

11. The method according to claim 10, in which a connecting piece forming the filling opening is oriented obliquely with respect to the center axis of the bushing sleeve and/or is formed monolithically with at least one layer of the jacket wall of the bushing sleeve.

12. The method according to claim 20, in which the bushing sleeve is provided with an outlet opening which is in a first state, when the bushing sleeve is inserted into the passage opening, and is brought into a second state under the pressure of flowable filling substance, in which second state an opening cross section of the outlet opening is greater than in the first state.

13. The method according to claim 20, in which an insertion portion of the bushing sleeve inserted into the passage opening is divided into a first axial portion which adjoins the flange part, and a second axial portion which follows the first axial portion axially away from the flange part, wherein a jacket wall of the bushing sleeve
is closed in the first axial portion, and
is provided with a plurality of outlet openings in the second axial portion.

14. The method according to claim 13, in which a spacer is provided at least in the second axial portion on an inner wall surface of the jacket wall of the bushing sleeve in order to keep the jacket wall of the bushing sleeve spaced apart from an outer wall surface of an empty pipe guided through.

15. The method according to claim 13, in which the bushing sleeve is formed elastically deformable at least in the second axial portion such that the jacket wall of the bushing sleeve is formed from an elastomer material.

16. The method according to claim 14, in which the bushing sleeve is formed rigidly at least in the second axial portion such that the jacket wall of the bushing sleeve is formed from a rigid material.

17. The method according to claim 13, in which the jacket wall of the bushing sleeve is constructed in several layers in the first axial portion, namely in a layer of an elastomer material, which is supported by a support sleeve has a further layer.

18. The method according to claim 15, in which the jacket wall of the bushing sleeve is constructed in several layers in the first axial portion, namely in a layer of an elastomer material, which is supported by a support sleeve as a further layer, and in which the layer of the first axial portion formed from the elastomer material and the jacket wall of the bushing sleeve of the second axial portion are formed monolithically with one another.

19. A method of using a line bushing, the method comprising the steps of:
obtaining a line bushing, the line bushing having a bushing sleeve, through which a line can be guided along a center axis of the bushing sleeve, and having a flange part for abutting against a side face of the wall or floor element,
wherein the bushing sleeve is tiltably mounted on the flange part for changing a tilt angle,
and wherein the tiltable mounting is realized via an elastomeric deformation element as a joint; and
inserting the bushing sleeve into a passage opening in a wall or floor element of a building, in such a way that the flange part abuts against a side face of the wall or floor element.

20. The method according to claim 19, wherein, in the line bushing, the center axis of the bushing sleeve, in an unloaded state, is perpendicular to a plane defined by the abutment of the flange part, but, in use, the passage opening is tilted relative to a surface normal on the side face, and the bushing sleeve, with deformation of the elastomeric deformation element, is fastened tilted relative to the flange part in the passage opening.
